(19) United States
(12) Patent Application Publication
(10) Pub. No.: US 2010/0001689 A1
(43) Pub. Date: Jan. 7, 2010

(54) MODULAR CHARGER

(75) Inventors: Carl Hultman, Derby, CT (US); Joseph Murtha, Monroe, CT (US); Mark Ross, Fairfield, CT (US); James Markland, Stratford, CT (US); William Frederick, Bridgeport, CT (US); Alexander P. DeSorbo, Woodbury, CT (US)

Correspondence Address: MCCORMICK, PAULDING & HUBER LLP, CITY PLACE II, 185 ASYLUM STREET, HARTFORD, CT, 06103, US

(73) Assignee: ANTON/BAUER, INC., Shelton, CT (US)

(21) Appl. No.: 12/496,750

(22) Filed: Jul. 2, 2009

Related U.S. Application Data
(60) Provisional application No. 61/077,500, filed on Jul. 2, 2008.

(51) Int. Cl. H02J 7/00

(52) U.S. Cl. 320/114; 320/107

(57) ABSTRACT

A charge module adapter for a power distribution system comprising an electric device, a rechargeable battery and an adapter module, wherein the adapter module is functionally interposed between the electric device and the battery, the adapter module being in electrical communication with the electric device and the battery, wherein the adapter module is configured to selectively distribute supplied power to the electric device and the battery, and wherein the adapter module determines the operating parameters of both the electric device and the battery, and operates to selectively provide power to the electric device and the battery in dependence upon the determined operating parameters.

### CROSS-REFERENCE TO RELATED APPLICATIONS

This application claims the benefit of U.S. Provisional Application No. 61/077,500, filed Jul. 2, 2008, entitled “MODULAR CHARGER”, the aforementioned application being hereby incorporated by reference in its entirety.

### FIELD OF THE INVENTION

The present invention relates generally to power supplies for electronic devices and, in particular, a modular charging system for powering a variety of electronic devices.

### BACKGROUND OF THE INVENTION

It is well known in the art that DC powered equipment, such as portable video cameras, monitors, recorder decks and the like, can be operated from either a battery or from mains power, i.e., a wired outlet, using an AC to DC converter. These converters, also referred to as power supplies, power such equipment when mains power is available or it is convenient to do so.

There are numerous power supply solutions (also known as “mains adapters” or similar monikers) in the marketplace, varying in physical size and power output. As I known, the internal construction of these devices contain circuitry to convert the line/mains voltage to DC.

The voltage and current requirements to power a host device—say, a standard 12 volt video camera—are markedly different that the voltage and current requirements to charge the battery that will operate that very same video camera. As will be readily appreciated, one cannot take a mains adapter for a camera and simply “plug it into” a battery in order to charge the battery. Nor can one take the output of a battery charger to power a camera as the electrical output necessary to charge the battery typically exceeds the voltage limit of the camera.

However, since battery chargers must have a core design block that consists of an AC to DC converter—that is, the charger must convert AC mains to a voltage (and current) level acceptable to charge a particular type of battery—battery chargers are sometimes combined with “power supplies” employing additional control techniques to allow a single device to either charge a battery or, when not serving that function, to operate as a AC adapter. The electronic design to configure such devices is also well known in the art. A well known use in the marketplace is for a consumer video camera to have a small plug-in-the-wall box which will physically accept the battery, by means of the same attachment means as to the camera for charging, or the box can be cabled to the camera through a separate output connection to power the camera as a mains adapter.

These uses are well known and the configuration of the switching electronics to create this flexibility is also well known and long established art in the portable electronics market. Some devices allow the charging of the battery to occur using the power from the AC to DC converter that is not required when the host devices is being powered. This allows for a single “box” to power and charge a battery at the same time.

However, a typical disadvantage to these devices is the requirement for adapters, special connectors or for separate electronic circuits and wiring to allow the single box to be both charger and “mains adapter” whether selectively or at the same time. Specialty devices, including one by the assignee of the present invention, have been designed to employ the same connection system to both battery and camera on two surfaces of the “box” or enclosure—one male and one female.

Thus, the power supply can be directly mounted or “sandwiched” between the battery and the host device to deliver DC power from AC mains or to charge a battery when the host does not require operating power or the power supply has unused capability.

These devices, such as the Anton/Bauer® Tandem® have been in the professional video market for many years and have achieved broad success stemming from the versatility and convenience of a single unit which can conveniently and cost effectively serve two requirements for DC powered equipment in the field. Moreover the ability to “piggy back” or “sandwich” the power options to a single host device allows the operator to use mains power when available or switch immediately and transparently to battery power when untethered mobility is required—without disconnecting or reconnecting devices or cables.

However, such power solutions have, up to now, addressed a single battery and single host devices. That is, the power supply/charger of known hybrid devices serve only a single host device and a single battery. Moreover, known camera and battery systems have “static” technology, i.e., the technology contained in the battery, camera and AC adapter is the same and/or is readily compatible. In a market such as professional video where TV stations may have several batteries for a single camera, an additional battery charger is required to service the remaining batteries. In that charger, again, is an AC to DC converter configured specifically for those batteries or battery charging station, and whose sole purpose is to provide the proper conversion of mains power sufficient to charge those particular, specific battery.

In view of the nature of the professional video market and similar markets, there is a need for a modular charger that can be used with a wide range of electric devices and batteries having different electrical characteristics, protocols and load parameters. In particular, there is a need for a universal charger that can be used with a wide range of batteries and electric devices and which can detect the load profile/requirements of the associated batteries and devices, and control the flow of electricity in accordance with the detected load profiles.

### SUMMARY OF THE INVENTION

In view of the foregoing, it is an object of the present invention to provide a charge module adapter capable of selectively providing power to variety of host devices.

It is another object of the present invention to provide a charge module adapter provided with a male side and a female side to facilitate the electro-mechanical connection of power sources and host devices.

It is another object of the present invention to provide a charge module adapter that is capable of determining the operating parameters of the devices to which it is attached and selectively providing power to these devices in dependence upon the respective operating parameters.

It is another object of the present invention to provide a modular charging system having a modular charger that is capable of selectively providing power to either a host DC powered device or an expansion charging module to which additional batteries can be attached and charged.

It is another object of the present invention to provide a modular charging system capable of simultaneously powering a host device and charging a battery for powering a host device.

It is another object of the present invention to provide a modular charging system capable automatically switching from mains power to battery power if mains power is interrupted.

It is another object of the present invention to provide a modular charging system having a modular charger that is capable of simultaneously or selectively charging a plurality of batteries.

### BRIEF DESCRIPTION OF THE DRAWINGS

The present invention will be better understood from reading the following description of non-limiting embodiments, with reference to the attached drawings, wherein below:

FIG. 1 illustrates a charge module adapter for a power distribution system in accordance with one embodiment of the present invention;

FIG. 2 illustrates a battery charging system in accordance with another embodiment of the present invention; and

FIG. 3 illustrates a charge module adapter and battery charging system in accordance with another embodiment of the present invention.

### DETAILED DESCRIPTION OF THE PREFERRED EMBODIMENT

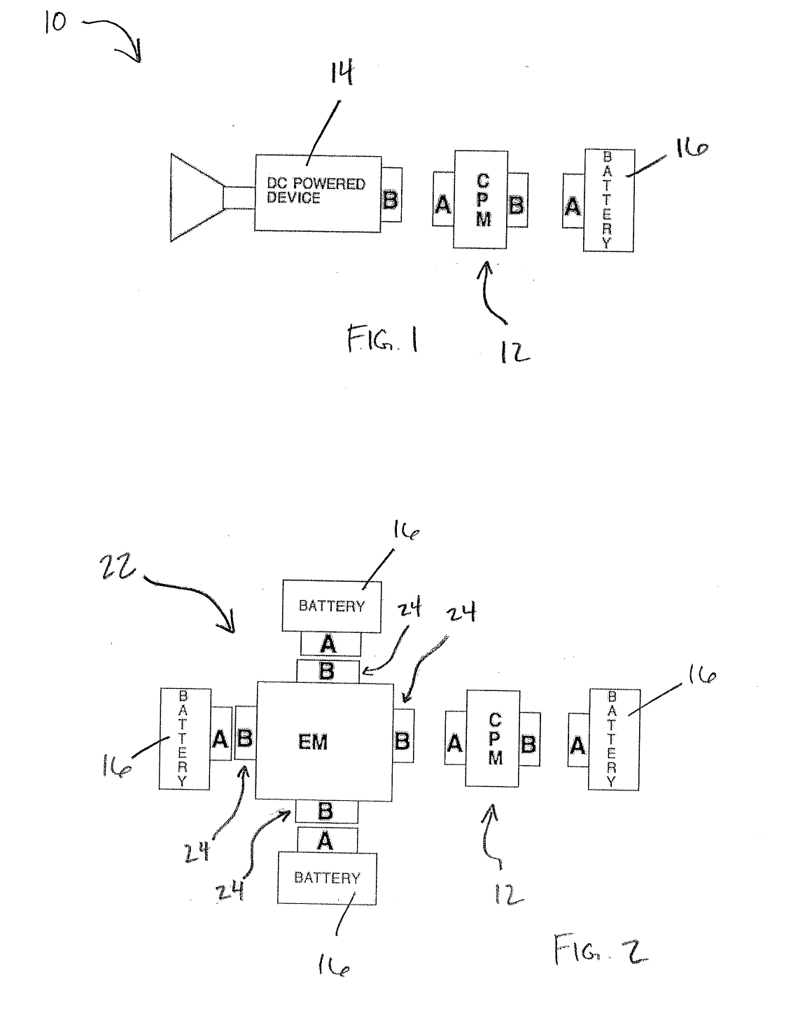

The present invention is directed to a modular charging system 10 that expands upon the capability and flexibility of known power supplies. In this system a single core power unit (CPM) 12 can be attached between a host device 14 and a rechargeable battery 16 in the usual fashion with the usual operating benefits—selectively or simultaneously powering the host device and charging a battery. This configuration is best illustrated in FIG. 1. In addition, however, when the new core power module 12 is separated from the host device 14 it can be attached to an expansion module (EM) 22, which allows for multiple batteries to be charged. This configuration is best illustrated in FIG. 2. Thus, a single core power unit for both powering the host device and charging a battery, and for charging multiple batteries attached to a separate expansion module device, can eliminate the need for the upfront cost and service life costs of multiple power supplies in multiple power devices.

In the preferred embodiment, the CPM 12 comprises an enclosure containing an AC-DC conversion device. One side of the enclosure provides a male electromechanical connection (A) (e.g., an Anton/Bauer® Gold Mount® or V-Mount®), while the other side provides a female electromechanical connection (B) of similar configuration suitable for attaching and connecting DC power sources to devices. It will be readily appreciated that the CPM male (A) and female (B) connectors have at least positive (+), negative (−) and communication electrical connections. These electromechanical male (A) and female (B) connectors provide for the secure and releasable attachment of DC batteries or power sources to DC powered devices and for the transmission of electricity therebetween. The inclusion of communications contacts on the connectors allow for the sharing of information and data between the host electric device 14 and the CPM 12 or between a rechargeable battery 16 and the CPM 12.

In particular, this configuration allows for the attachment of a battery 16 to the female-side connection (B) for charging of the battery, and attachment of a host device 14 to the male-side connection (A) for powering of the device. In operation, if mains power to the CPM 12 is interrupted, the CPM 12 will detect this condition and immediately draw upon the battery 16 attached to the female side (B) of the CPM to power the host device 14, resulting in uninterrupted power delivery to the host device. Moreover, the CPM 12 may be configured to charge the battery 16 attached to the female side (B) if substantially no current is being drawn by the host device 14 and AC mains is present, such as may be the case if the host device is turned off or is in “sleep mode.”

Preferably, the CPM 12 also features electronic communication to identify, and responsive control to adjust, the output of the AC-DC conversion device to selectively provide power to either a host DC powered device 14 (e.g., a camera, monitor, recorder or the like) or an expansion charging module 22 to which additional batteries 16 may be attached and charged. In operation, when the CPM 12 is attached to a host device 14, such as a standard 12-volt camera, the CPM 12 recognizes that it is attached to a host device 14 (e.g. video camera) and sets its output for the proper voltage and current to safely power the host device 14. More specifically, the control circuitry determines the operating parameters of both the electric device 14 and the battery 16, and operates to selectively provide power to the electric device 14 and the battery 16 in dependence upon the determined operating parameters. The functionality of the CPM in situations where it is attached to an expansion module is described in detail below.

Thus, it will be readily appreciated that the CPM 12 functions as a universal adapter capable of providing power to a wide range of electric devices having different electrical characteristics, protocols and power and charge parameters. The CPM 12, as a result of the internal circuitry and charge control logic, is also capable of charging a wide array of battery types and chemistries, such as NiMH, NiCad, Li-Ion, SLA, Li-Poly, AgZn and NiZn. In another embodiment, the CPM may also include a USB port or other means for the remote upgrading of software to allow for the charging and powering of additional batteries and devices moving forward, as they become available.

As noted above, an expansion module (EM) 22 is also part of the modular charging system of the present invention. In the preferred embodiment, the EM 22 is a charging device having one or more charging positions 24 having female electromechanical connections (B) for attaching one or more batteries to the EM charging device 22, and which contains switching and electronic means. Preferably, the electromechanical connectors (A), (B) are of the same type as those provided on the CPM 12 (i.e., Anton/Bauer Gold Mount or V-Mount), although other connector configurations are possible. The EM 22 consists primarily of the logic and control circuitry requisite to battery charging. That is, each charging position 24 has a female connector (B) for the attachment of a battery and corresponding electronics controls to manage the charging of the attached battery 16. As with the CPM 12, the EM 22 male and female connectors (A),(B) may have at least positive (+), negative (−) and communication electrical connections. In an another embodiment, however, the electrical connection between the CPM 12 and any host device 14 may employ at least one different electrical contact than the connection between the CPM 12 and EM 22, and may not include a separate communications contact.

When the CPM 12 is attached to an EM 22, the two communicate electronically and the CPM 12 correspondingly adjusts the output to the electrical connection on the CPM 12 normally configured to properly power the host device, to provide the input into the EM 22 (to provide for the battery charging function) at a different voltage and current output. That is, in the case where the CPM 12 is attached to the EM 22, the CPM 12 enables the EM 22 to provide charge current, voltage and control to one or more batteries 16 attached to the EM 22.

In this way a single power supply can be a more versatile field device—a single position lightweight battery charger and a direct mount AC mains adapter, shown in FIG. 1—as well as provide the power to another device to create a multi-position battery charging system, shown in FIG. 2.

In yet another embodiment of the present invention, the expansion module 22 may contain charge control logic that can determine the available maximum power of the power supply and the number of batteries attached to the expansion module. Existing multi-position chargers usually employ either simultaneous charging or sequential charging. Known multi-position chargers featuring simultaneous charging usually divide the current available from the power supply by the number of potential charge positions on the charger and provide each charging position with a proportional amount of current. In other words, a 4 position simultaneous charger with a 4 amp power supply nominally provides 1 amp per charge position. On the other hand, known multi-position chargers that employ sequential charging will provide all of the available current from the power supply to a single charge position until the associated battery is fully charged, then switch to the next charge position and associated battery until that battery is fully charged, and so forth.

With the present system, charge control logic provides for selectable current flow to any of the charge positions in the battery charging system such that the maximum available charge current, from 100% to a number equal to 100% divided by the number of batteries actually presented to the charger, is always supplied to a given battery. In particular, with any multi-station charging system so equipped with this charge control logic, the actual number of batteries attached to the system is first determined. The available current from the power supply is then divided by the actual number of batteries attached to the system, rather than dividing the current based on the number that could be presented to the charger. That is, rather than dividing the current based on the number of charge positions, used or not, of the multi-position charger, the present invention divides the current based on the actual number of charge positions used. For example a power supply capable of providing 4 amps of charge current could be used entirely by one battery at a time or shared among the total number of batteries presented to the system. Thus the system could charge a single battery faster or a multiplicity of batteries faster, than if the charger logic was dedicated in the typical sequential or simultaneous charging approach.

It will be readily appreciated that the control circuitry of the EM 22 may take any form provided that it can distinguish between active and non-active stations, and that the control circuitry, in combination with the charge control logic, can detect the type of battery or batteries 16 attached to the EM 22. Such charge control logic and control circuitry enables the EM 22 to determine the operating parameters of each battery 16 attached to the device and tailor the output thereto. In particular, the EM 22 has the ability to charge multiple chemistries, such as NiMH, NiCad, Li-Ion, SLA, Li-Poly, AgZn and NiZn.

In yet another embodiment, the EM 22 may have a USB port or other means for the remote upgrading of EM software for charging additional chemistries moving forward, as they become available. This feature would allow a user to connect the EM 22 to a computer via the USB port and download and install software upgrades to provided added functionality to the EM, such as the charging of future batteries as they become available.

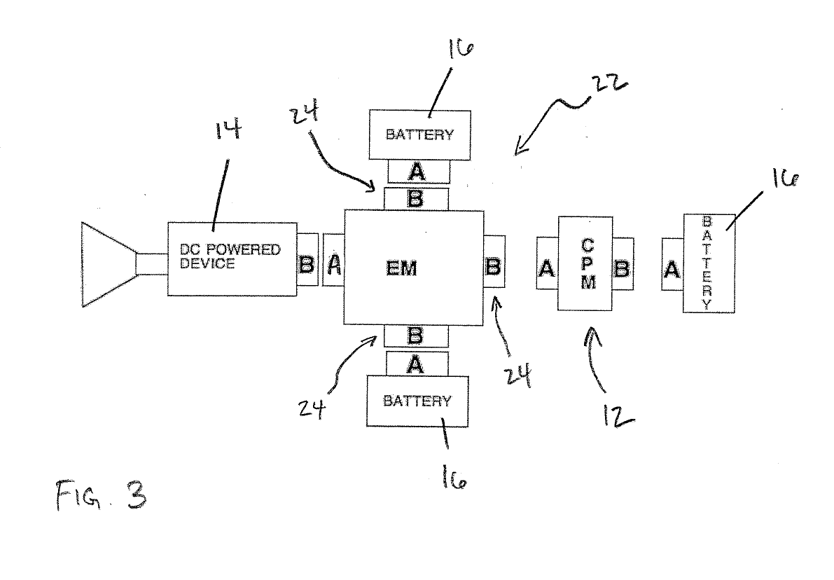

In yet another embodiment, one of the charging stations may be adaptable to support an electric device 14, such as a camcorder or video camera, and the like. This configuration, as shown in FIG. 3, would allow for the running of the electric device 14 while simultaneously recharging the batteries 16 attached to the system, each of which may be of the same or different type.

While the embodiments described above contemplate the use of mains power, i.e., a wired wall outlet, as a power source for the CPM, the present invention is not so limited in this regard. In particular, the present invention may be used with any known power sources, AC and non-AC, such as solar, wind, battery (such as a car charger) and the like to power the CPM. The use of these alternative power sources provide an added mobility and modularity to the present invention.

While the invention has been described with reference to the preferred embodiments, it will be understood by those skilled in the art that various obvious changes may be made, and equivalents may be substituted for elements thereof, without departing from the essential scope of the present invention. Therefore, it is intended that the invention not be limited to the particular embodiments disclosed, but that the invention includes all embodiments falling within the scope of the appended claims.

What is claimed is:

1. A charge module adapter for a power distribution system, comprising:
an electric device;
a rechargeable battery; and
an adapter module;
wherein said adapter module is functionally interposed between said electric device and said battery, said adapter module being in electrical communication with said electric device and said battery;
wherein said adapter module is configured to selectively distribute supplied power to said electric device and said battery; and
wherein said adapter module determines the operating parameters of both said electric device and said battery, and operates to selectively provide power to said electric device and said battery in dependence upon said determined operating parameters.

2. The charge module adapter of claim 1, wherein:
said adapter module includes a male connection for the releasable attachment of one of said electric device and said rechargeable battery, and a female connection for the releasable attachment of the other of said electric device and said rechargeable battery.

3. The charge module adapter of claim 2, wherein:
said male and female connections include positive and negative contacts for the transmission of electricity, and at least one communication contact for the transmission of data.

4. The charge module adapter of claim 1, wherein:
said adapter module is configured to charge said rechargeable battery if substantially no current is being drawn by said electric device.

5. The charge module adapter of claim 1, wherein:
said adapter module is configured to channel power to said electric device from said rechargeable battery if mains power to said electric device is interrupted.

6. The charge module adapter of claim 1, wherein:
one of said operating parameters is a chemistry of said rechargeable battery.

7. The charge module adapter of claim 1, wherein:
one of said operating parameters is an operating load of said electric device.

8. The charge module adapter of claim 2, wherein:
said electric device is a video camera.

9. The charge module adapter of claim 1, wherein:
said electric device is an expansion module having a plurality of docking stations for releasably mounting rechargeable batteries thereto.

10. The charge module adapter of claim 9, wherein:
said expansion module includes control circuitry for controlling the distribution of electrical power to each of said plurality of docking stations; and
wherein said control circuitry determines which of said plurality of stations have a rechargeable battery mounted thereto and simultaneously charges each of said batteries by dividing a total power output by a total number of active stations.

11. The charge module adapter of claim 1, wherein:
said adapter module includes a USB port for remotely updating software installed theron to allow for the charging and powering of additional battery and device types.

12. A battery charging system, comprising:
an expansion module, said expansion module having a plurality of docking stations for releasably mounting rechargeable batteries thereto, and control circuitry for controlling the distribution of electrical power to each of said plurality of stations;
wherein said control circuitry determines which of said plurality of stations have a rechargeable battery mounted thereto and simultaneously charges each of said batteries by dividing a total power output by a total number of active stations.

13. The battery charging system of claim 12, further comprising:
an adapter module releasably attached to, and in electrical communication with, said expansion module;
wherein said adapter module is configured to selectively distribute supplied power to said expansion module; and
wherein said adapter module determines the operating parameters of said expansion module and operates to selectively provide power to said expansion module in dependence upon said determined operating parameters.

14. The battery charging system of claim 12, wherein:
said control circuitry determines the operating parameters of each of said rechargeable batteries and operates to selectively provide power to each of said rechargeable batteries in dependence upon said determined operating parameters.

15. The battery charging system of claim 14, wherein:
one of said operating parameters is a chemistry of each of said rechargeable batteries.

16. The battery charging system of claim 12, wherein:
each of said docking stations include a female connection for the releasable mounting of one of said rechargeable batteries to said expansion module.

17. The battery charging system of claim 16, wherein:
said female connection includes positive and negative contacts for the transmission of electricity, and at least one communication contact for the transmission of data.

18. The battery charging system of claim 13, wherein:
one of said charging stations is adaptable to support an electric device so that said electric device may be run while each of said rechargeable batteries is being charged.

19. The battery charging system of claim 18, wherein:
said electric device is a video camera.

20. The battery charging system of claim 12, wherein:
said expansion module includes a USB port for remotely updating software installed theron to allow for the charging of additional batteries types.
